(19) United States
(12) Patent Application Publication
(10) Pub. No.: US 2023/0237186 A1
(43) Pub. Date: Jul. 27, 2023

(54) Access Control Framework For Graph Entities

(71) Applicant: Dell Products L.P., Round Rock, TX (US)

(72) Inventors: Mustafa M. Albasha, Round Rock, TX (US); Michael Shepherd, Leander, TX (US)

(21) Appl. No.: 17/581,554

(22) Filed: Jan. 21, 2022

(51) Int. Cl. G06F 21/62; G06F 21/60; G06F 16/245

(52) U.S. Cl. CPC G06F 21/6227; G06F 21/604; G06F 16/245

(57) ABSTRACT

A system can receive a database query that is associated with a user account and that is directed to a first database that stores graph data. The system can determine, based on information received from a second database, whether the user account has authorization to make the database query, wherein the second database stores graph metadata information about the first database, and wherein a schema of the second database corresponds to data entities of the first database and relations between respective data entries of the first database. The system can in response to determining from the second database that the user account has the authorization to make the database query, perform the database query with respect to the first database to produce a query result, and return the database query result to be accessible via a device associated with authenticated use of the user account.

### BACKGROUND

A graph database can comprise a form of a relational database. A graph can comprise nodes and edges that connect nodes. A graph database can associate data in a database with nodes in a graph, and relationships between the data in the database with edges in the graph.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive a database query that is associated with a user account and that is directed to a first database that stores graph data. The system can determine, based on information received from a second database, whether the user account has authorization to make the database query, wherein the second database stores graph metadata information about the first database, wherein the second database is separate from the first database, and wherein a schema of the second database corresponds to data entities of the first database and relations between respective data entries of the first database. The system can in response to determining from the second database that the user account has the authorization to make the database query, perform the database query with respect to the first database to produce a query result, and return the database query result to be accessible via a device associated with authenticated use of the user account.

A method can comprise receiving, by a system comprising a processor, a query that is originated from a user account and that is directed to a first database that stores graph data. The method can further comprise determining, by the system and from a second database, whether the user account has authorization to make the database query, wherein the second database stores metadata information about the first database, and wherein a schema of the second database corresponds to data entities of the first database and relations between respective data entries of the first database. The method can further comprise, in response to determining, by the system and from the second database, that the user account is authorized to make the database query, returning a result of performing the query on the first database to the user account.

An example non-transitory computer-readable medium can comprise instructions that, in response to execution, cause a system comprising a processor to perform operations. These operations can comprise receiving a query that is originated from activity via authenticated use of a user account and that is directed to a first database that stores graph data. These operations can further comprise determining, from information obtained from a second database, whether the user account has authorization to make the database query, wherein a schema of the second database corresponds to data entities of the first database and relations between respective data entries of the first database. These operations can further comprise, in response to determining from the second database that the user account has the authorization to make the database query, returning a result of performing the query with respect to the first database for access via authenticated use of the user account.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate an access control framework for graph entities, in accordance with an embodiment of this disclosure;

FIG. 2 illustrates another example system architecture that can facilitate an access control framework for graph entities, in accordance with an embodiment of this disclosure;

FIG. 3 illustrates an example system architecture that can facilitate an access control framework for graph entities, in accordance with an embodiment of this disclosure;

FIG. 4 illustrates an example process flow that can facilitate an access control framework for graph entities, in accordance with an embodiment of this disclosure;

FIG. 5 illustrates another example process flow that can facilitate an access control framework for graph entities, in accordance with an embodiment of this disclosure;

FIG. 6 illustrates another example process flow that can facilitate an access control framework for graph entities, in accordance with an embodiment of this disclosure;

FIG. 7 illustrates another example process flow that can facilitate an access control framework for graph entities, in accordance with an embodiment of this disclosure;

FIG. 8 illustrates another example process flow that can facilitate an access control framework for graph entities, in accordance with an embodiment of this disclosure;

FIG. 9 illustrates another example process flow that can facilitate an access control framework for graph entities, in accordance with an embodiment of this disclosure;

FIG. 10 illustrates another example process flow that can facilitate an access control framework for graph entities, in accordance with an embodiment of this disclosure;

FIG. 11 illustrates another example process flow that can facilitate an access control framework for graph entities, in accordance with an embodiment of this disclosure;

FIG. 12 illustrates an example block diagram of a computer operable to execute an embodiment of this disclosure.

### DETAILED DESCRIPTION

### Overview

Compliance failures regarding data security can result in fines by regulatory agencies. A cost of compliance can be prohibitive unless managed pro-actively and efficiently. To address these problems with compliance, the present techniques can be implemented to embed compliance into a process framework, as well as to manage, harness, and leverage data imperative (e.g., a granularity of data and an ability to construct individual data elements).

Disparate data sets (e.g., telemetry and business data) can be unified, along with creating an ecosystem that can accelerate worker productivity.

Security frameworks according to the present techniques can be implemented that provide access control and compliance at an individual data entity level, by a group or a user. In some prior approaches to relational database management systems (RDBMSes), access is provided at the level of a table, a column, or a row. The present techniques can be implemented to agnostically integrate with multiple types of data sources (e.g., various databases or data store types) and destinations, and to provide access control at a level of a graph data entity.

Prior approaches can leave information technology (IT) and security with a lack of traceability into who is doing what with what data, which can leave IT and security without confidence in their data ecosystem. A result can be that a burden of bureaucracy is placed on individuals attempting to get access to data, while at the same time, there can be a rush to remove access from anyone who cannot prove they still need it.

This can lead to a complex problem left to IT to balance business needs against a threat of breaches, and can indicate that visibility access control, compliance, and contextualization of metadata from users is important.

A problem with prior approaches can be that there is not a granular cell, or entity, access.

Another problem with prior approaches can be that they are unable to enforce compliance at the entity level.

The present techniques can be implemented to utilize capabilities provided by GraphDB to provide access control on entities across data sources and enforce compliance on other databases. Access control and compliance logic can be added to metadata schema. The metadata schema can represent security data models and provide role-based or attribute base access control into data entities of a system. Similarly, compliance models can be applied to metadata schema models to enforce attribute based compliance according to different contexts, such as region, user, or organizational group.

The present techniques can be implemented to provide a security data model/anthology schema that represents primarily data nodes and relationships between those data nodes, in addition to other defined data entities, and can be utilized to map access and compliance control on a data source system transaction.

The present techniques can facilitate a data serving layer to enforce schema access control and compliance on any entity. The data entity referred can comprise a data node and/or relationship data between data nodes. vA data node entity can comprise a single or multiple properties. A data relationship entity can comprise a single or multiple properties.

### Example Architectures

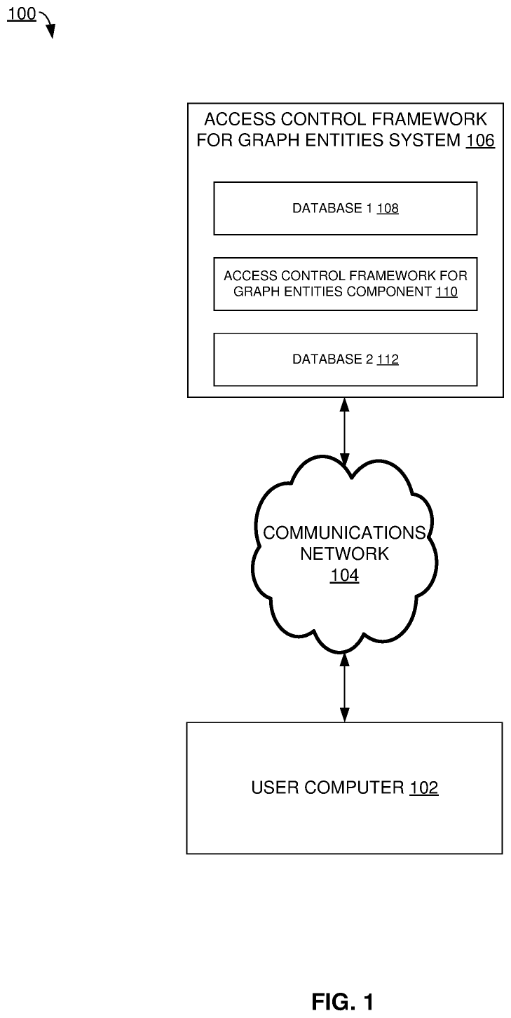

FIG. 1 illustrates an example system architecture 100 that can facilitate an access control framework for graph entities, in accordance with an embodiment of this disclosure.

As depicted, system architecture 100 comprises user computer 102, communications network 104, and access control framework for graph entities system 106. In turn, access control framework for graph entities system 106 comprises database 1 108, access control framework for graph entities component 110, and database 2 112.

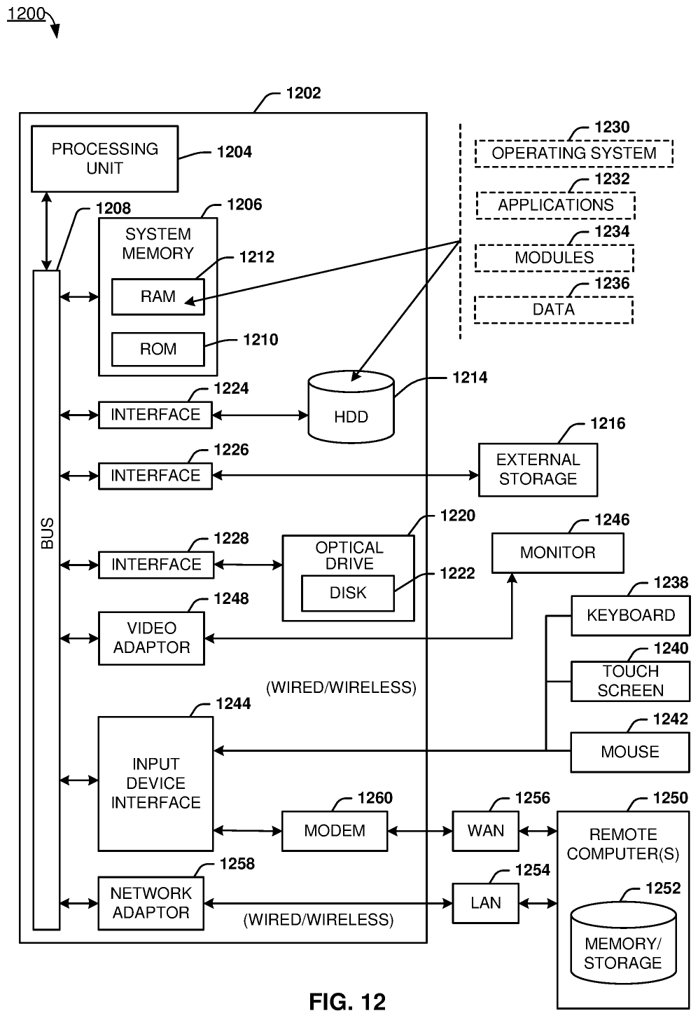

Each of user computer 102 and access control framework for graph entities system 106 can be implemented with part(s) of computing environment 1200 of FIG. 12. Communications network 104 can comprise a computer communications network, such as the Internet.

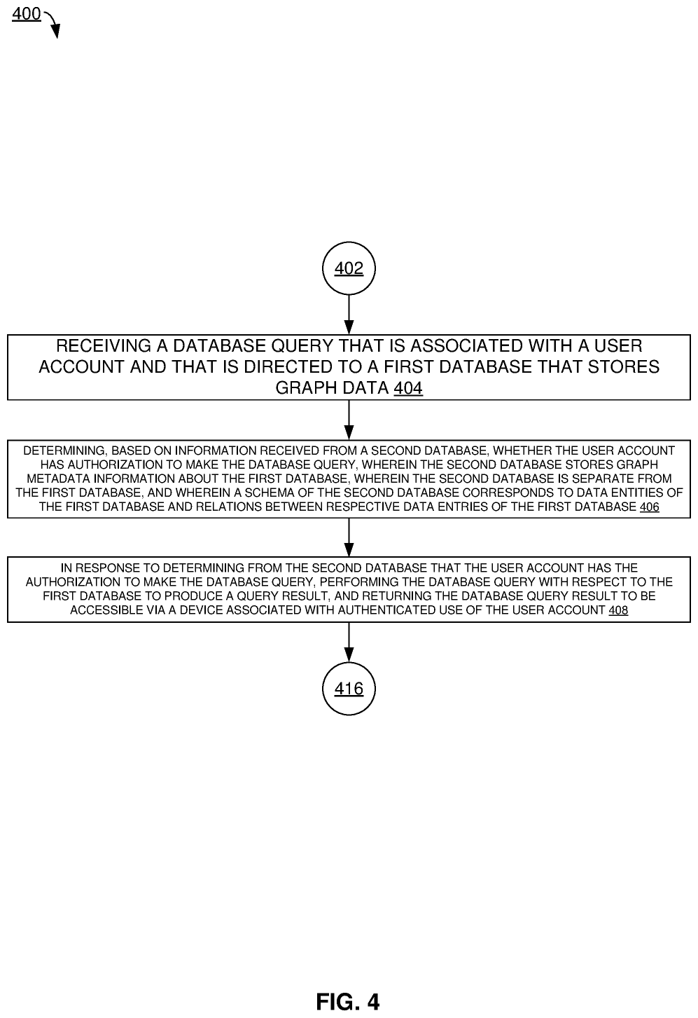

In some examples, access control framework for graph entities component 110 can implement part(s) of the process flows of FIGS. 4-11 to facilitate access control framework for graph entities.

User computer 102 can communicate with access control framework for graph entities system 106 via communications network 104 to access data in database 1 108 via database queries. Access control framework for graph entities component 110 can determine from database 2 112 whether a user account associated with user computer 102 has access to perform a particular query.

A schema of database 2 112 can be created based on the entities and relationships of database 1 108. In this manner, database 1 108 and database 2 112 can be agnostically linked (e.g., linked regardless of what schema is used in database 1 108). As metadata for database 1 108 is created, this metadata can be stored in database 2 112.

It can be appreciated that system architecture 100 is one example system architecture for extracting facial imagery from online sessions, and that there can be other system architectures that facilitate extracting facial imagery from online sessions.

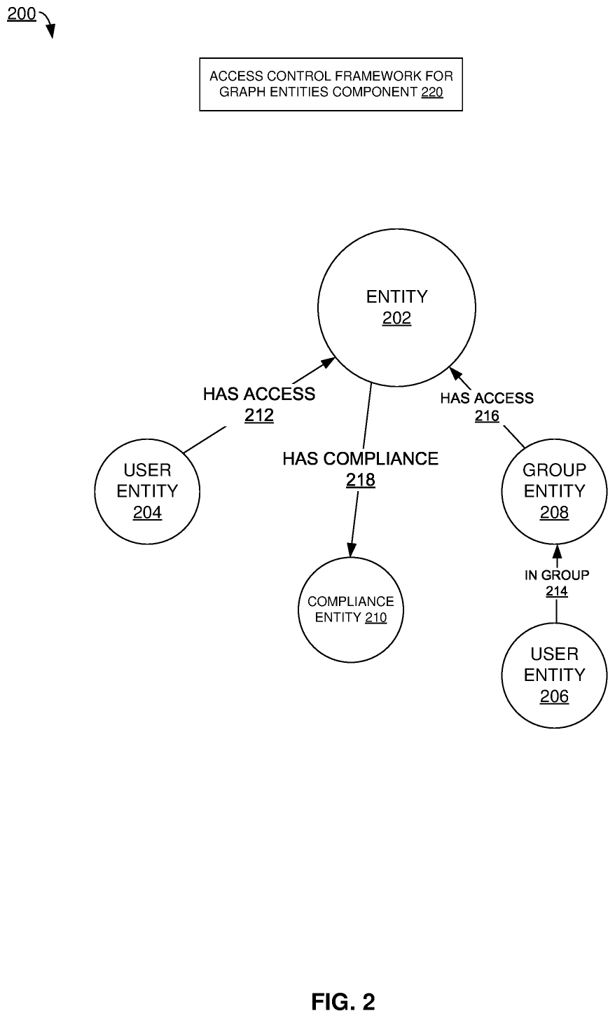

FIG. 2 illustrates another example system architecture 200 that can facilitate an access control framework for graph entities, in accordance with an embodiment of this disclosure. In some examples, part(s) of system architecture 200 can be used to implement database 2 112 of FIG. 1.

System architecture 200 comprises entity 202, entity 204, entity 206, entity 208, entity 210, relation 212, relation 214, relation 216, relation 218, and access control framework for graph entities component 220 (which can be similar to access control framework for graph entities component 110 of FIG. 1).

Entity 202 can comprise a data entity from database 1 108. Information about entity 202 that can be stored includes a category label (which can be a string), a description (which can be a string), tags (which can be an array of strings), a type (which can be a string), a source (which can be a string), and a destination (which can be a string).

Entity 204 is connected to entity 202 via relation 212. Relation 212 indicates that a user account identified by entity 204 has access to entity 202. Entity 204 can store a user name (which can be a string), a first name of a person associated with the user name (which can be a string), and a last name of a person associated with the user name (which can be a string). Relation 212 can indicate a type of access (e.g., read, write, create, or delete), a start time of the access (which can be a date), and an end time of the access (which can be a data).

Entity 208 is connected to entity 202 via relation 216. Relation 216 indicates that a user group identified by entity 208 has access to entity 202. Entity 208 can store a name of the user group (which can be a string), a description of the user group (which can be a string), and a function of the user group (which can be a string). Similar to relation 212, relation 216 can indicate a type of access (e.g., read, write, create, or delete), a start time of the access (which can be a date), and an end time of the access (which can be a data).

Entity 206 is connected to entity 208 via relation 214. Relation 214 indicates that a user account identified by entity 206 is a member of a user group identified by entity 208. Like entity 204, entity 206 can store a user name (which can be a string), a first name of a person associated with the user name (which can be a string), and a last name of a person associated with the user name (which can be a string).

Entity 202 is connected to entity 210 via relation 218. Relation 218 indicates that entity 202 has a compliance requirement indicated by entity 210. Entity 210 can store compliance information including a mask flag (which can be a Boolean), and a block all flag (which can be a Boolean).

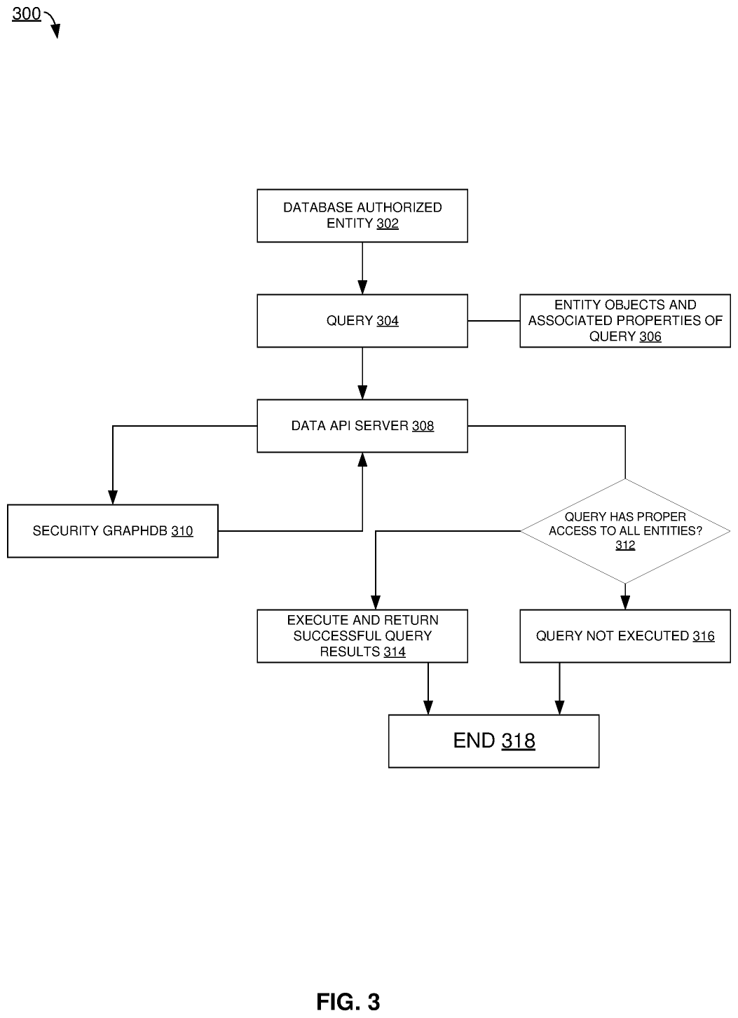

FIG. 3 illustrates an example system architecture 300 that can facilitate an access control framework for graph entities, in accordance with an embodiment of this disclosure. In some examples, part(s) of system architecture 300 can be used to implement access control framework for graph entities component 110 of FIG. 1.

System architecture 300 comprises database authorized entity 302, query 304, entity objects and associated properties of query 306, data application programming interface (API) server 308, security GraphDB 310, query has proper access to all entities? 312, execute and return successful query results 314, query not executed 316, and end 318.

Database authorized entity 302 can be an entity (e.g., a user account) that is authorized to generally access a database, such as user computer 102 of FIG. 1 accessing database 1 108. Database authorized entity 302 can issue query 304 to database 1 108, where query 304 can identify certain entities that are subject to the query.

Query 304 can be received by data API server 308 (which can be similar to database 1 108). Data API server 308 can check access for each entity in query 304 with security GraphDB 310 (which can be similar to database 2 112 of FIG. 1). Security GraphDB 310 can return access check results to data API server 308. After the access check results are returned, it can be determined in query has proper access to all entities? 312 whether database authorized entity 302 has access to each entity identified in query 304.

Where the result of query has proper access to all entities? 312 is Yes, then execute and return successful query results 314 can be performed. Otherwise, where the result of query has proper access to all entities? 312 is No, then query not executed 316 can be performed, which can include returning a failure due to access violation to database authorized entity 302. At the conclusion of both execute and return successful query results 314 and query not executed 316, end 318 can be reached, where processing the query can be concluded.

### Example Process Flows

FIG. 4 illustrates an example process flow 400 that can facilitate an access control framework for graph entities, in accordance with an embodiment of this disclosure. In some examples, one or more embodiments of process flow 400 can be implemented by access control framework for graph entities component 110 of FIG. 1, or computing environment 1200 of FIG. 12.

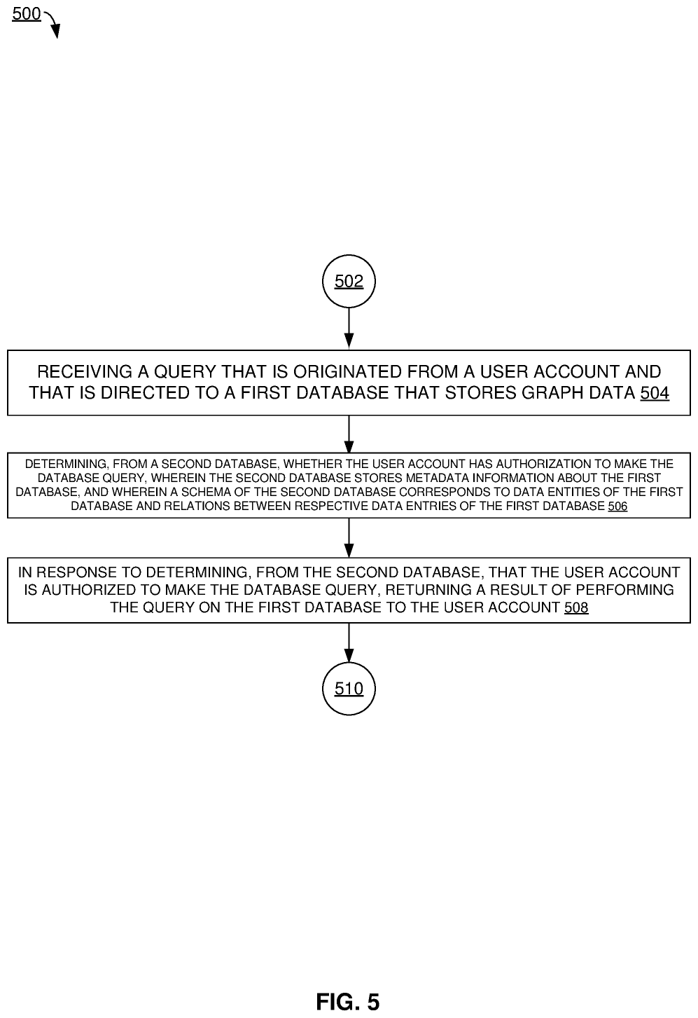

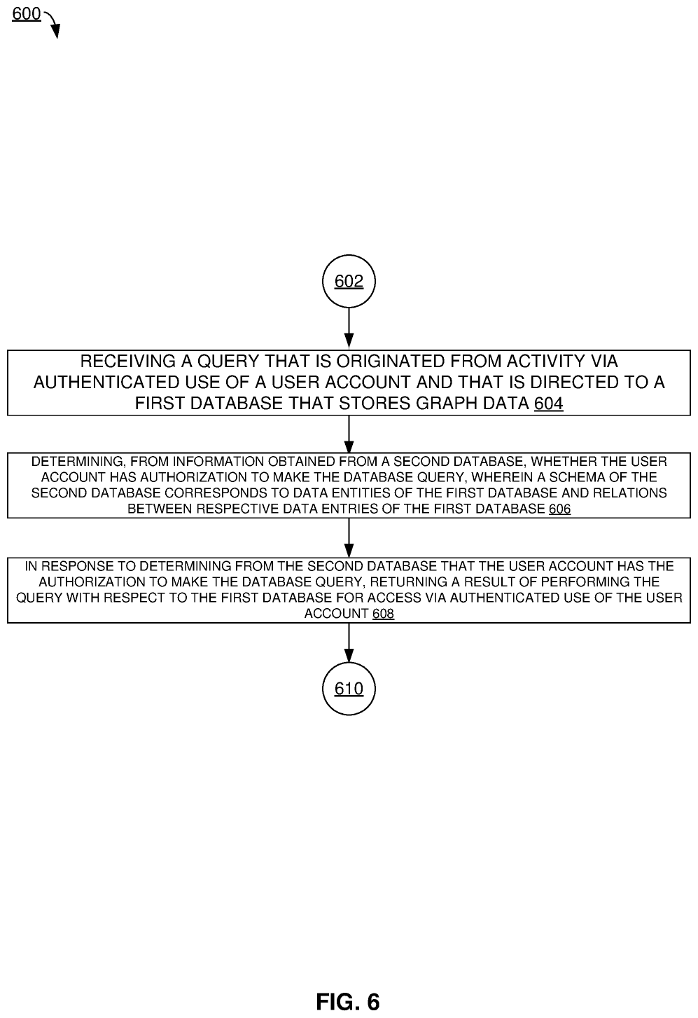

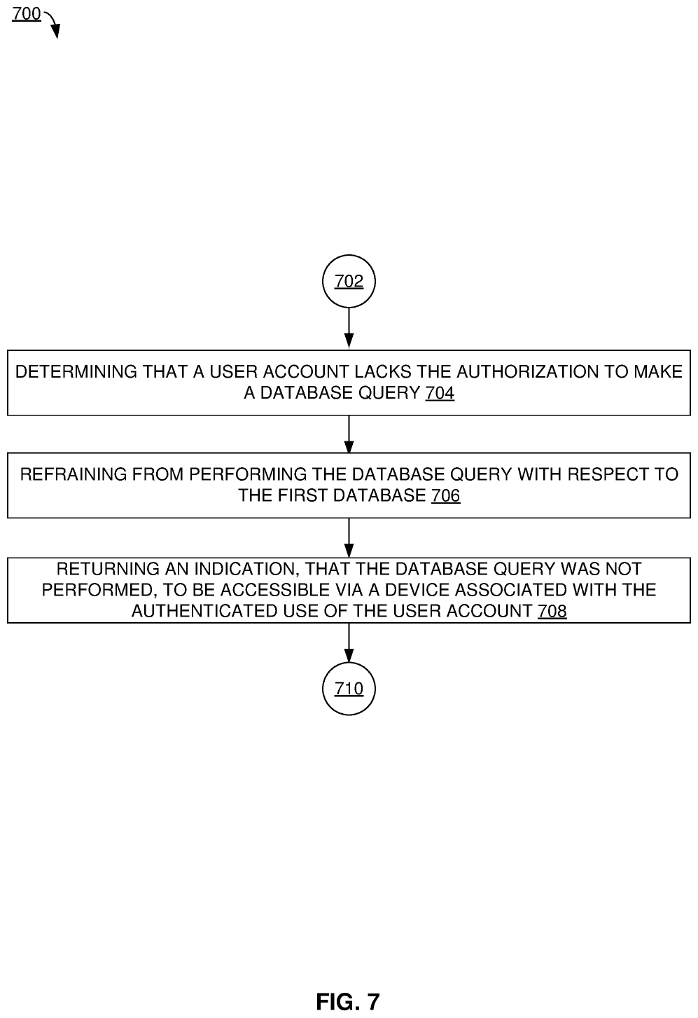

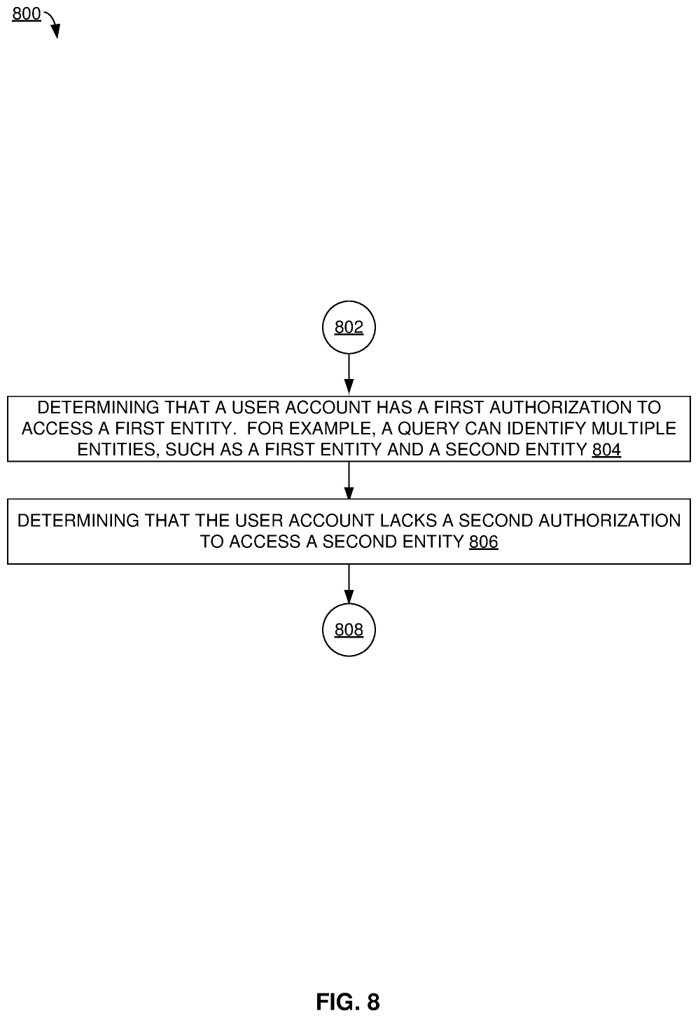

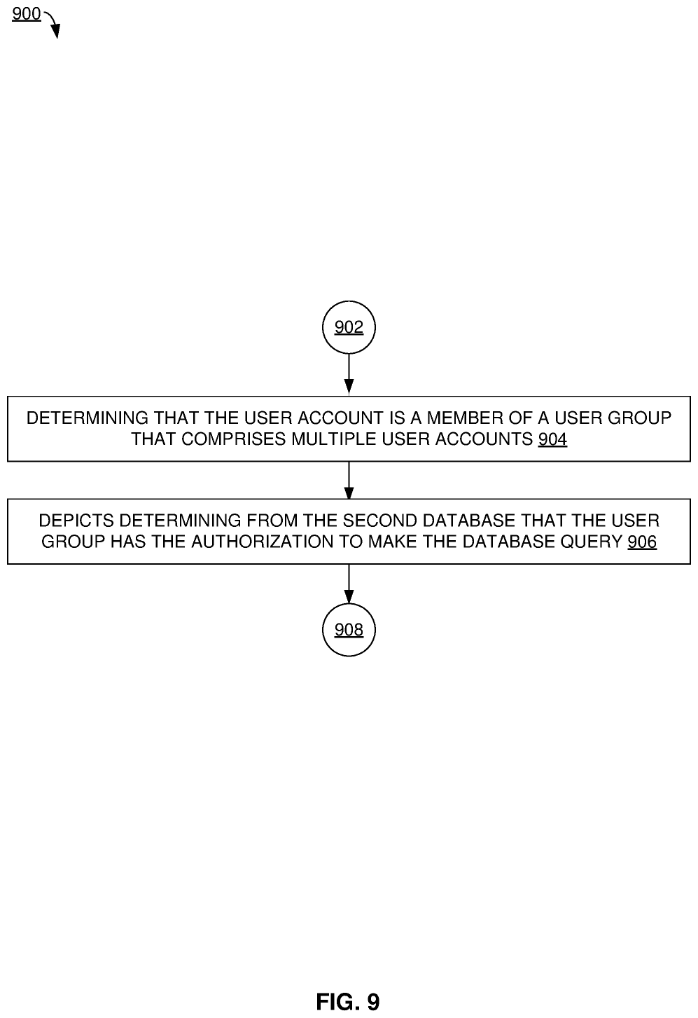

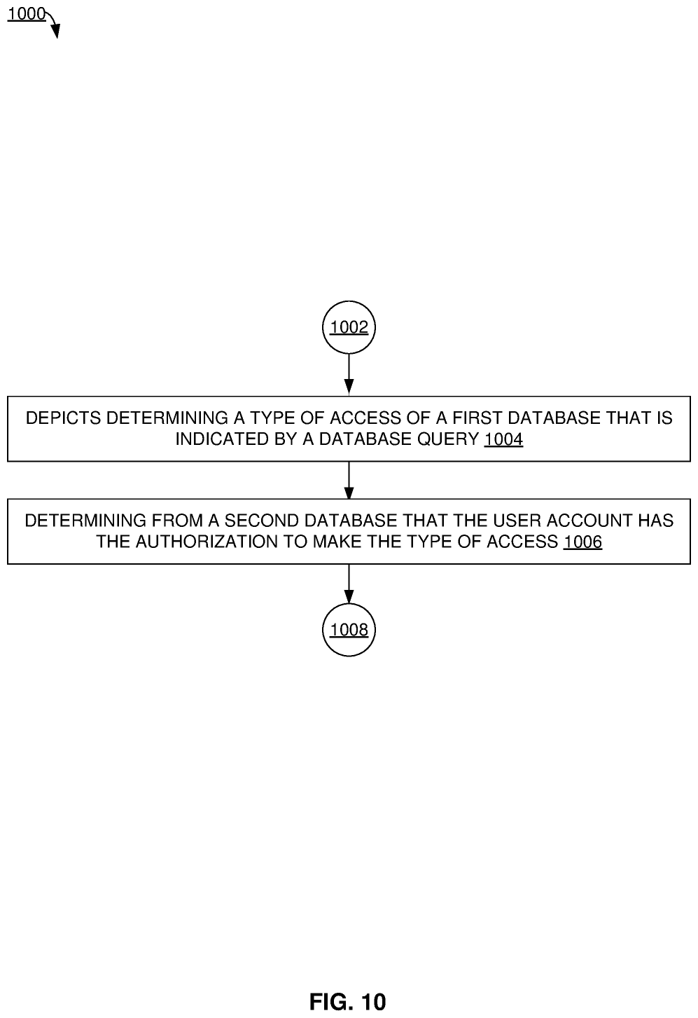

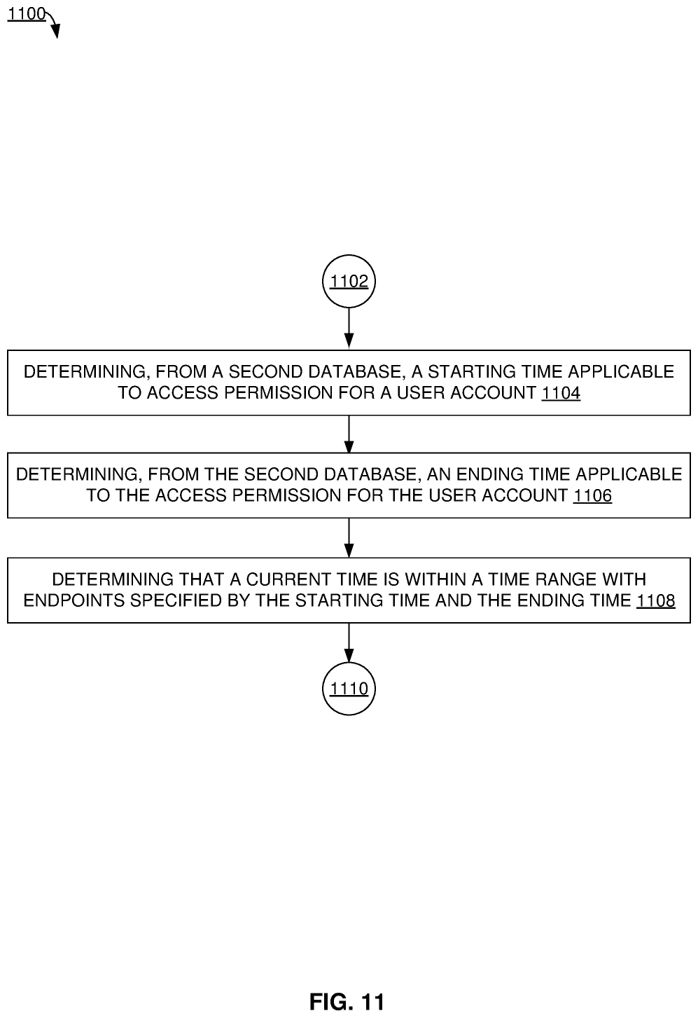

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 400 begins with 402, and moves to operation 404. Operation 404 depicts receiving a database query that is associated with a user account and that is directed to a first database that stores graph data. This can be a query originated by user computer 102 of FIG. 1, and that is directed toward database 1 108.

After operation 404, process flow 400 moves to operation 406.

Operation 406 depicts determining, based on information received from a second database, whether the user account has authorization to make the database query, wherein the second database stores graph metadata information about the first database, wherein the second database is separate from the first database, and wherein a schema of the second database corresponds to data entities of the first database and relations between respective data entries of the first database. The second database can be database 2 112 of FIG. 1. The second database can maintain access control information for entities of the first database, and can be checked to determine whether the user account that originated the query has access to perform the query on the first database.

In some examples, operation 406 comprises determining, based on the information received from the second database, that the user account has the authorization to access an entity of the first database, wherein the entity differs from a table of the first database, a column of the first database, or a row of the first database. That is, access control can be performed at the level of a single entity.

After operation 406, process flow 400 moves to operation 408.

Operation 408 depicts, in response to determining from the second database that the user account has the authorization to make the database query, performing the database query with respect to the first database to produce a query result, and returning the database query result to be accessible via a device associated with authenticated use of the user account. That is, where it is determined from the second database that the user account is authorized to perform the query, performing the query on the first database, and returning the result to the user account.

After operation 408, process flow 400 moves to 410, where process flow 400 ends.

FIG. 5 illustrates another example process flow 500 that can facilitate an access control framework for graph entities, in accordance with an embodiment of this disclosure. In some examples, one or more embodiments of process flow 500 can be implemented by access control framework for graph entities component 110 of FIG. 1, or computing environment 1200 of FIG. 12.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 500 begins with 502, and moves to operation 504. Operation 504 depicts receiving a query that is originated from a user account and that is directed to a first database that stores graph data. In some examples, operation 504 can be implemented in a similar manner as operation 404 of FIG. 4.

After operation 504, process flow 500 moves to operation 506.

Operation 506 depicts determining, from a second database, whether the user account has authorization to make the database query, wherein the second database stores metadata information about the first database, and wherein a schema of the second database corresponds to data entities of the first database and relations between respective data entries of the first database. In some examples, operation 506 can be implemented in a similar manner as operation 406 of FIG. 4.

In some examples, operation 506 comprises storing an identification of the user account in an entity in the second database. In some examples, this comprises storing a username of the user account, a given name of a person associated with the user account, or a surname of the associated with the user account. That is, information about user accounts can be stored in the second database, similar to entity 204 or entity 206 of FIG. 2.

In some examples, operation 506 comprises storing an identification of a user group, with which the user account is associated, in an entity in the second database. In some examples, this comprises storing a name of the user group, a description of the user group, or a function of the user group. That is, information about user groups can be stored in the second database, similar to entity 208 of FIG. 2.

After operation 506, process flow 500 moves to operation 508.

Operation 508 depicts, in response to determining, from the second database, that the user account is authorized to make the database query, returning a result of performing the query on the first database to the user account. In some examples, operation 508 can be implemented in a similar manner as operation 408 of FIG. 4.

In some examples, operation 508 comprises, in response to creating a new entity in the first database, updating, based on the new entity in the first database, the schema of the second database. That is, the schema of the second database (e.g., database 2 112 of FIG. 1) can be based on data stored in the first database (e.g., database 1 108). When the first database is updated to create a new entity, then the schema of the second database can be correspondingly updated.

After operation 508, process flow 500 moves to 510, where process flow 500 ends.

FIG. 6 illustrates another example process flow 600 that can facilitate an access control framework for graph entities, in accordance with an embodiment of this disclosure. In some examples, one or more embodiments of process flow 600 can be implemented by access control framework for graph entities component 110 of FIG. 1, or computing environment 1200 of FIG. 12.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, process flow 900 of FIG. 9, process flow 1000 of FIG. 10, and/or process flow 1100 of FIG. 11.

Process flow 600 begins with 602, and moves to operation 604. Operation 604 depicts receiving a query that is originated from activity via authenticated use of a user account and that is directed to a first database that stores graph data.

After operation 604, process flow 600 moves to operation 606.

Operation 606 depicts determining, from information obtained from a second database, whether the user account has authorization to make the database query, wherein a schema of the second database corresponds to data entities of the first database and relations between respective data entries of the first database.

In some examples, a relationship between a first entity of the second database that represents the user account and a second entity of the second database that represents a third entity of the first database indicates whether the user account has access to the third entity of the first database. That is, relations in the second database (e.g., database 2 112 of FIG. 1) can be used to indicate access permissions in the first database (e.g., database 1 108).

In some examples, a relationship between entities of the second database indicates whether the user account is a member of a user group, whether the user account or the user group has access to an entity of the first database, or indicates whether the entity of the first database meets a compliance requirement. That is, relations can indicate information similar to that of relation 212, relation 214, relation 216, and relation 218 of FIG. 2.

In some examples, a compliance requirement for accessing the first database is indicated by an entity of the second database. In some examples, the entity of the second database is a first entity, the second database comprises a second entity that represents an entity of the first database, and a relationship between the first entity and the second entity indicates the compliance requirement for the entity of the first database. That is, a relationship between an entity and a compliance requirement can indicate that there is a compliance requirement for that entity.

In some examples, the first entity comprises a description of the compliance requirement, a tag of the compliance requirement, a type of the compliance requirement, a source of the compliance requirement, or a destination of the compliance requirement. That is, certain types of information can be stored for a compliance requirement, and the first entity can be similar to entity 210 of FIG. 2.

After operation 606, process flow 600 moves to operation 608.

Operation 608 depicts, in response to determining from the second database that the user account has the authorization to make the database query, returning a result of performing the query with respect to the first database for access via authenticated use of the user account.

After operation 608, process flow 600 moves to 610, where process flow 600 ends.

FIG. 7 illustrates another example process flow 700 that can facilitate an access control framework for graph entities, in accordance with an embodiment of this disclosure. Process flow 700 can be implemented to handle cases where a user account attempts to perform a query on a first database, and it is determined from a second database that the user account lacks access to perform the query. In some examples, one or more embodiments of process flow 700 can be implemented by access control framework for graph entities component 110 of FIG. 1, or computing environment 1200 of FIG. 12.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, process flow 900 of FIG. 9, process flow 1000 of FIG. 10, and/or process flow 1100 of FIG. 11.

Process flow 700 begins with 702, and moves to operation 704. Operation 704 depicts determining that a user account lacks the authorization to make a database query. This can be performed by checking user access in database 2 112 of FIG. 1 to make the query in database 1 108.

After operation 704, process flow 700 moves to operation 706.

Operation 706 depicts refraining from performing the database query with respect to the first database. That is, when it is determined in the second database that the user account lacks access to make the query, then it can be that the query is not performed on the first database.

After operation 706, process flow 700 moves to operation 708.

Operation 708 depicts returning an indication, that the database query was not performed, to be accessible via a device associated with the authenticated use of the user account. That is, an indication that the user account lacks access to make the query can be returned to user computer 102 of FIG. 1.

After operation 708, process flow 700 moves to 710, where process flow 700 ends.

FIG. 8 illustrates another example process flow 800 that can facilitate an access control framework for graph entities, in accordance with an embodiment of this disclosure. Process flow 800 can be implemented to handle cases where a user account attempts to perform a query that involves multiple entities, and where user access for each of these entities is checked. In some examples, one or more embodiments of process flow 800 can be implemented by access control framework for graph entities component 110 of FIG. 1, or computing environment 1200 of FIG. 12.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, process flow 900 of FIG. 9, process flow 1000 of FIG. 10, and/or process flow 1100 of FIG. 11.

Process flow 800 begins with 802, and moves to operation 804. Operation 804 depicts determining that a user account has a first authorization to access a first entity. For example, a query can identify multiple entities, such as a first entity and a second entity. In such examples, determining whether the user account has access to perform the query can comprise determining whether the user account has access to each identified entity. Here, it can be determined that the user account has access to a first entity.

After operation 804, process flow 800 moves to operation 806.

Operation 806 depicts determining that the user account lacks a second authorization to access a second entity. In contrast to operation 804 where it is determined that the user account has access to the first entity, here it can be determined that the user account lacks access to a second entity. It can be that performing the query requires the user account having access to all entities identified in the query. Since the user account lacks access to the second entity, then it can be determined that the user account lacks access to performing the entire query.

After operation 806, process flow 800 moves to 808, where process flow 800 ends.

FIG. 9 illustrates another example process flow 900 that can facilitate an access control framework for graph entities, in accordance with an embodiment of this disclosure. Process flow 900 can be implemented to handle cases where a user account is a member of a user group, and the user group has various access permissions. In some examples, one or more embodiments of process flow 900 can be implemented by access control framework for graph entities component 110 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 1000 of FIG. 10, and/or process flow 1100 of FIG. 11.

Process flow 900 begins with 902, and moves to operation 904. Operation 904 depicts determining that the user account is a member of a user group that comprises multiple user accounts. That is, it can be determined that the user account corresponds to entity 206 of FIG. 2, and relation 214 indicates that entity 206 is related to entity 208, which identifies a user group. So, it can be determined that the user account is a member of the user group.

After operation 904, process flow 900 moves to operation 906.

Operation 906 depicts determining from the second database that the user group has the authorization to make the database query. User groups can have access permissions, and where a user group has a particular access permission, it can be that each user account associated with that user group has that access permission. Here, it can be determined that the user account has access to perform a query because the user account is a member of a user group that has access to make the query.

After operation 906, process flow 900 moves to 908, where process flow 900 ends.

FIG. 10 illustrates another example process flow 1000 that can facilitate an access control framework for graph entities, in accordance with an embodiment of this disclosure. Process flow 1000 can be implemented to handle cases where a user account has a particular type of access permission for an entity. In some examples, one or more embodiments of process flow 1000 can be implemented by access control framework for graph entities component 110 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1100 of FIG. 11.

Process flow 1000 begins with 1002, and moves to operation 1004. Operation 1004 depicts determining a type of access of a first database that is indicated by a database query. In some examples, a user account's access to an entity can be of a specific type (e.g., read, or modify). This access type can be stored in database 2 112 of FIG. 1, where the query is for database 1 108.

In some examples, the type of access comprises a reading type pertaining to reading from an entity in the first database, a writing type pertaining to writing to the entity in the first database, a creating type pertaining to creating the entity in the first database, or a deleting type pertaining to deleting the entity in the first database.

After operation 1004, process flow 1000 moves to operation 1006.

Operation 1006 depicts determining from a second database that the user account has the authorization to make the type of access. That is, where it is determined from database 2 112 of FIG. 1 that the user account has the type of access specified in the query, the query can be performed on database 1 108.

After operation 1006, process flow 1000 moves to 1008, where process flow 1000 ends.

FIG. 11 illustrates another example process flow 1100 that can facilitate an access control framework for graph entities, in accordance with an embodiment of this disclosure. Process flow 1100 can be implemented to handle cases where there is a time window during which access is permitted. In some examples, one or more embodiments of process flow 1100 can be implemented by access control framework for graph entities component 110 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 1100 begins with 1102, and moves to operation 1104. Operation 1104 depicts determining, from a second database, a starting time applicable to access permission for a user account. For instance, relation 212 and relation 216 of FIG. 2 can indicate a starting time for access of entity 202 by entity 204 (identifying a user) and entity 208 (identifying a user group), respectively.

After operation 1104, process flow 1100 moves to operation 1106.

Operation 1106 depicts determining, from the second database, an ending time applicable to the access permission for the user account. Similar to operation 1104, this ending time can be indicated by relation 212 and relation 216 of FIG. 2.

After operation 1106, process flow 1100 moves to operation 1108.

Operation 1108 depicts determining that a current time is within a time range with endpoints specified by the starting time and the ending time. Where the current time is within the access time range indicated by the second database, then the query can be performed. Where the current time is outside of this access time range, then it can be that the query is not performed.

After operation 1108, process flow 1100 moves to 1110, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of user computer 102 and/or access control framework for graph entities system 106 of FIG. 1.

In some examples, computing environment 1200 can implement one or more embodiments of the process flows of FIGS. 4-11 to facilitate an access control framework for graph entities.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving a database query that is associated with a user account and that is directed to a first database that stores graph data;
determining, based on information received from a second database, whether the user account has authorization to make the database query, wherein the second database stores graph metadata information about the first database, wherein the second database is separate from the first database, and wherein a schema of the second database corresponds to data entities of the first database and relations between respective data entries of the first database; and
in response to determining from the second database that the user account has the authorization to make the database query,
performing the database query with respect to the first database to produce a query result, and
returning the database query result to be accessible via a device associated with authenticated use of the user account.

2. The system of claim 1, wherein the determining that the user account has the authorization to make the database query comprises:
determining, based on the information received from the second database, that the user account has the authorization to access an entity of the first database, wherein the entity differs from a table of the first database, a column of the first database, or a row of the first database.

3. The system of claim 1, wherein the operations further comprise:
in response to determining that the user account lacks the authorization to make the database query,
refraining from performing the database query with respect to the first database; and
returning an indication, that the database query was not performed, to be accessible via a device associated with the authenticated use of the user account.

4. The system of claim 3, wherein the database query identifies a first entity of the first database and a second entity of the first database, and wherein the determining that the user account lacks the authorization to make the database query comprises:
determining that the user account has a first authorization to access the first entity; and
determining that the user account lacks a second authorization to access the second entity.

5. The system of claim 1, wherein the determining that the user account has the authorization to make the database query comprises:
determining that the user account is a member of a user group that comprises multiple user accounts; and
determining from the second database that the user group has the authorization to make the database query.

6. The system of claim 1, wherein the determining that the user account has the authorization to make the database query comprises:
determining a type of access of the first database that is indicated by the database query; and
determining from the second database that the user account has the authorization to make the type of access.

7. The system of claim 6, wherein the type of access comprises a reading type pertaining to reading from an entity in the first database, a writing type pertaining to writing to the entity in the first database, a creating type pertaining to creating the entity in the first database, or a deleting type pertaining to deleting the entity in the first database.

8. A method, comprising:
receiving, by a system comprising a processor, a query that is originated from a user account and that is directed to a first database that stores graph data;
determining, by the system and from a second database, whether the user account has authorization to make the database query, wherein the second database stores metadata information about the first database, and wherein a schema of the second database corresponds to data entities of the first database and relations between respective data entries of the first database; and
in response to determining, by the system and from the second database, that the user account is authorized to make the database query, returning a result of performing the query on the first database to the user account.

9. The method of claim 8, wherein the determining that the user account is authorized to make the database query comprises:
determining, from the second database, a starting time applicable to access permission for the user account;
determining, from the second database, an ending time applicable to the access permission for the user account; and
determining that a current time is within a time range with endpoints specified by the starting time and the ending time.

10. The method of claim 8, further comprising:
storing, by the system, an identification of the user account in an entity in the second database.

11. The method of claim 10, wherein storing the identification of the user account in the entity in the second database comprises:
storing, by the system, a username of the user account, a given name of a person associated with the user account, or a surname of the associated with the user account.

12. The method of claim 8, further comprising:
storing, by the system, an identification of a user group, with which the user account is associated, in an entity in the second database.

13. The method of claim 12, wherein storing the identification of the user group comprises:
storing, by the system, a name of the user group, a description of the user group, or a function of the user group.

14. The method of claim 8, further comprising:
in response to creating a new entity in the first database, updating, by the system and based on the new entity in the first database, the schema of the second database.

15. A non-transitory computer-readable medium comprising instructions that, in response to execution, cause a system comprising a processor to perform operations, comprising:
receiving a query that is originated from activity via authenticated use of a user account and that is directed to a first database that stores graph data;
determining, from information obtained from a second database, whether the user account has authorization to make the database query, wherein a schema of the second database corresponds to data entities of the first database and relations between respective data entries of the first database; and
in response to determining from the second database that the user account has the authorization to make the database query, returning a result of performing the query with respect to the first database for access via authenticated use of the user account.

16. The non-transitory computer-readable medium of claim 15, wherein a relationship between a first entity of the second database that represents the user account and a second entity of the second database that represents a third entity of the first database indicates whether the user account has access to the third entity of the first database.

17. The non-transitory computer-readable medium of claim 15, wherein a relationship between entities of the second database indicates whether the user account is a member of a user group, whether the user account or the user group has access to an entity of the first database, or indicates whether the entity of the first database meets a compliance requirement.

18. The non-transitory computer-readable medium of claim 15, wherein a compliance requirement for accessing the first database is indicated by an entity of the second database.

19. The non-transitory computer-readable medium of claim 18, wherein the entity of the second database is a first entity, wherein the second database comprises a second entity that represents an entity of the first database, and wherein a relationship between the first entity and the second entity indicates the compliance requirement for the entity of the first database.

20. The non-transitory computer-readable medium of claim 18, wherein the first entity comprises a description of the compliance requirement, a tag of the compliance requirement, a type of the compliance requirement, a source of the compliance requirement, or a destination of the compliance requirement.
